(19) United States
(12) Patent Application Publication
(10) Pub. No.: US 2020/0002098 A1
(43) Pub. Date: Jan. 2, 2020

(54) Graph Associated with a Packaging Plant

(71) Applicant: SIG Technology AG, Neuhausen am Rheinfall (CH)

(72) Inventor: Matthias Eickhoff, Alsdorf (DE)

(21) Appl. No.: 16/482,552

(22) PCT Filed: Feb. 6, 2018
(86) PCT No.: PCT/EP2018/052945

§ 371 Date: Jul. 31, 2019

(30) Foreign Application Priority Data
Feb. 15, 2017 (DE) 10 2017 102 992.3

(51) Int. Cl. B65G 43/10; G06F 16/901; G05B 15/02

(52) U.S. Cl. CPC B65G 43/10; G05B 15/02; G06F 16/9024

(57) ABSTRACT

Among other things, a method is disclosed that is performed by a data processing device comprising the following: obtaining and/or determining graph data representing a graph associated with a packaging plant, wherein the graph comprises a plurality of nodes and a plurality of edges, wherein each edge from the plurality of edges connects two nodes from the plurality of nodes with one another, wherein each node from the plurality of nodes represents a component of the packaging plant, and wherein each edge from the plurality of edges represents a possible packaging process connection between two components of the packaging plant: and storing of the graph data in a memory the data processing device.

### BACKGROUND

Various packaging plants are known in which a plurality of different components are used, such as heating systems, filling machines, applicators to apply closures and/or drinking straws, switches, chutes, bulk packers and cartoners. In order to be able to perform different packaging processes, in these packaging plants switches are used, by use of which one or a plurality of components could be bypassed and/or additionally served. In complex packaging plants with a plurality of switches for the separation and/or combination of packaging process connections in particular, this results in a plurality of packaging processes that are feasible by the packaging plant.

### SUMMARY OF A NUMBER OF EXEMPLARY EMBODIMENTS OF THE INVENTION

In order to monitor a packaging plant of this type and the packaging process performed by the packaging plant, it can for example be desirable to create a representation of the packaging process performed by the packaging plant and for example to be able to display this to a user on a monitoring device. In order to do this, a displayable representation of each of the different packaging processes that are feasible by a packaging plant can be predetermined and corresponding data stored in a memory of the monitoring device so that the correct representation simply has to be selected and the corresponding data loaded from the memory for display. However, this is associated with a high memory requirement as data of a corresponding representation have to be stored in the memory for each of the packaging processes that are feasible by the packaging plant. Furthermore, in the event of any changes to the packaging plant (e.g. addition and/or removal of one or several components) all representations of the packaging processes that are feasible by the packaging plant have to be predetermined again and corresponding data stored in a memory of the monitoring device.

The object of present invention was therefore inter-alia to overcome one or more of the above-described disadvantages.

According to the invention, a method performed by a data processing device is disclosed comprising the following:
obtaining and/or determining graph data, wherein the graph data represent a graph associated with a packaging plant, wherein the graph comprises a plurality of nodes and a plurality of edges, wherein each edge from the plurality of edges connects two nodes from the plurality of nodes with one another, wherein each node from the plurality of nodes represents a component of the packaging plant, and wherein each edge from the plurality of edges represents a possible packaging process connection between two components of the packaging plant; and
Storing of the graph data in a memory of the data processing device.

The method according to the invention is for example a method for obtaining and/or generating graph data that represent a graph for the determining of a representation of a packaging process that is feasible by a packaging plant.

Furthermore, according to the invention, a computer program is disclosed that comprises program instructions that cause a processor to perform and/or control the method according to the invention when the computer program is executed by the processor. Either all of the steps of the method can be controlled, or all of the steps of the method can be performed, or one or more steps can be controlled and one or more steps performed.

In this specification, a processor should be understood to mean, inter alia, control units, microprocessors, microcontrol units such as microcontrollers, Digital Signal Processors (DSPs), Application-Specific Integrated Circuits (ASICs) or Field Programmable Gate Arrays (FPGAs).

The computer program can for example be shareable via the internet, a telephone or mobile communications network and/or a local network. The computer program can be at least in part software and/or firmware of a processor. It can equally be implemented in part as hardware.

The computer program can for example be stored on a machine-readable storage medium such as a magnetic, electric, optic and/or other type of storage medium. The storage medium can for example be part of a processor, for example a (non-volatile/persistent or volatile) program memory of the processor or a part of it. The storage medium can for example be a tangible or physical storage medium.

Furthermore, according to the invention, a data processing device is disclosed that is configured to perform and/or control the method according to the invention or comprising the respective means for performing and/or controlling the steps of the method according to the invention. Either all of the steps of the method according to the invention can be controlled, or all of the steps of the method according to the invention can be performed by the means, or one or more steps can be controlled and one or more steps can be performed by the means. Various steps can optionally be implemented or controlled by various means.

The means of the disclosed data processing device can comprise hardware and/or software components. The means can for example comprise a memory with program instructions of a computer program (e.g. the computer program according to the invention) and at least one processor configured for executing program instructions from the at least one memory. Correspondingly, according to the invention, at least one data processing device should be understood to be disclosed that comprises at least one processor and at least one memory with program instructions, wherein the at least one memory and the program instructions are configured to cause, together with the at least one processor, the data processing device to perform and/or to control the method according to the invention.

The data processing device according to the invention is for example a monitoring device for a packaging plant.

Furthermore, according to the invention, a system is disclosed that comprises the following:
a data processing device according to the invention; and
a packaging plant.

The properties and features of the method according to the invention, the computer program according to the invention, the data processing device according to the invention and the system according to the invention are described below, in some cases by means of an example.

As disclosed at the outset, a packaging plant is for example a plant for the packaging of goods such as foods. In particular, a packaging plant should be understood to mean a beverage filling plant and/or part of a beverage filling plant. A plurality of various components are often used in plants of this type such as heating systems (e.g. heating systems for the ultra-high-temperature heating of the filling material), filling machines, applicators for the application of closures and/or drinking straws, switches (e.g. switches for the separation and/or combination of packaging process connections), shrinkers, chutes, bulk packers, palletisers, buffers, vertical storages and cartoners. Various applications run on these components (e.g. in the form of a computer program run by a processor of these components). The various components and applications of the packaging plant can at least partially provide packaging plant status data.

A graph that is associated with a packaging plant should be understood for example to be a structure (e.g. a structure that can be represented in graphical form) that represents a plurality of components of the packaging plant in the form of nodes together with the packaging process connections that exist between this plurality of components of the packaging plant in the form of edges. A packaging process connection is for example a connection between two of the components in the packaging plant that can be used during a packaging process that is feasible by the packaging plant. A packaging process connection of this type can for example be formed by a conveyor line (e.g. as a conveyor belt and/or as a roller conveyor) between the output of a component and the input of another component in the packaging plant. If a component of the packaging plant has various outputs that are connected to inputs of various components of the packaging plant, each of these packaging process connections can for example be represented by a respective edge from the plurality of edges. Accordingly, a graph of this type can show all packaging processes that are feasible by the packaging plant associated with the graph (e.g. represent them graphically).

The graph data represent the graphs for example by definitions of the plurality of nodes and/or the plurality of edges of the graph contained in the graph data. For example, the graph data contain, for each node from the plurality of nodes, a node data structure that defines the respective node and/or, for each edge from the plurality of edges, an edge data structure that defines the respective edge. A node data structure contains, for example, data to identify and/or describe the node. Furthermore, a node data structure can for example contain metadata that identify and/or describe the component of the packaging plant represented by the node and/or logic data that describe the functionality of the component (e.g. a functionality of a switch and/or a chute). An edge data structure contains, for example, data to identify and/or describe the edge such as data that identify the two nodes connected by the edge. Furthermore, an edge data structure can also contain metadata and/or logic data. It is to be understood that the graph data are not limited to these data structures and may, alternatively or additionally, contain other data structures.

The obtaining of graph data should for example be understood that the graph data are received by the data processing device via a communication connection and/or read from a portable storage device and/or record in the form of user input. For example, the data processing device can comprise corresponding means such as a communication interface (e.g. a network adapter) for receiving data and/or a storage interface (e.g. a drive and/or a drive interface) for reading of data from a portable memory and/or a user interface (e.g. a screen such as a touch-sensitive screen, a keyboard, a mouse, a microphone and/or a camera) for recording of data in the form of a user input.

Alternatively or in addition, the graph data can be determined by the data processing device. The determining of the graph data should be understood to mean generating and/or calculating the graph data. The determining of the graph data can for example be performed at least partially based on data obtained by the data processing device (e.g. data received by the data processing device via a communication connection and/or read by a portable storage device and/or recorded in the form of a user input) and/or at least partially based on predefined rules (e.g. rules of an algorithm) for determining of a graph associated with a packaging plant and/or for determining of graph data that represent a graph associated with a packaging plant.

The graph data are stored in a memory of the data processing device. The memory of the data processing device can be a non-volatile memory (e.g. a program memory) of the data processing device and/or a volatile memory (e.g. a main memory) of the data processing device. A program memory should be understood for example to be the memory of the data processing device in which computer programs, program instructions and data are permanently stored. An example of a program memory of a data processing device is a hard drive. A main memory is for example the memory of the data processing device that contains the computer programs and/or program instructions executed by a processor of the data processing device and in which for example interim results or the like can be stored (e.g. cached). An example of a main memory of a data processing device is an RAM memory (Random Access Memory memory) such as a DRAM memory (Dynamic Random Access Memory memory).

As disclosed above, the graph can represent all of the packaging processes that are feasible by the packaging plant associated with the graph. The storing of graph data is therefore a particularly efficient option for the storing of representations of the packaging processes that are feasible by the packaging plant associated with the graph. It is not necessary for each of the packaging processes that is feasible by the packaging plant associated with the graph to determine its own representation and to store corresponding data. In the event of any changes to the packaging plant (e.g. the addition and/or removal of one or several components), only the graph (and not the plurality of representations) needs to be adapted.

Further properties and features of the method according to the invention, the computer program according to the invention, the data processing device according to the invention and the system according to the invention are explained below using exemplary embodiments of the invention.

According to an exemplary embodiment of the invention, the packaging plant is configured to perform at least two different packaging processes.

A packaging process should be understood to mean the process of packaging a good (e.g. the process of filling a beverage into a packaging and of further processing the filled packaging). In order to perform a packaging process of this type, the packaging plant can comprise various components such as heating systems (e.g. heating systems for the ultra-high-temperature heating of the filling material), filling machines, applicators for the application of closures and/or drinking straws, switches (e.g. switches for the separation and/or combination of packaging process connections), shrinkers, chutes, bulk packers, palletisers, buffers, vertical storages and cartoners. The at least two different packaging processes may differ for example by the components of the packaging plant involved in performing of the packaging process.

In order for one packaging plant to be able to perform various packaging processes, components with several outputs and/or inputs (e.g. switches) can be provided in the packaging plant which enable the bypassing of components in the packaging plant. For example, applicators to apply closures and/or drinking straws can be bypassed if no closures and/or drinking straws are to be applied to the packaging in a packaging process. In another packaging process, however, the applicators for applying closures and/or drinking straws are served in order to apply closures and/or drinking straws to the packaging.

According to an exemplary embodiment of the invention, the method further comprises:
obtaining of packaging plant status data, wherein the packaging plant status data are indicative of a packaging process that is feasible by the packaging plant; and
determining of a representation of the packaging process that is feasible by the packaging plant at least partially based on the packaging plant status data and the graph represented by the graph data.

The packaging plant status data are for example communicated by one or more components of the packaging plant via a communication connection to the data processing device. The packaging plant status data are obtained for example by receiving the packaging plant status data by the data processing device. Alternatively or additionally, the packaging plant status data can be recorded at least in part in the form of a user input. For example, as disclosed above, the data processing device can comprise appropriate means such as a communication interface for receiving data and/or a user interface for recording of data in the form of a user input.

Various packaging processes may differ for example by the components of the packaging plant involved in performing of the packaging process. Accordingly, the packaging plant status data can for example contain information on the activity and/or the active output of one or more components of the packaging plant. Information on the activity of a component of the packaging plant is for example indicative of whether the component in the packaging plant is active during the packaging process (i.e. is involved in the packaging process) and/or is inactive during the packaging process (i.e. is not involved in the packaging process). Information on the active output of a component of the packaging plant is for example indicative of which output of the component is active during the packaging process (i.e. is used during the packaging process) and which output of the component is inactive during the packaging process (i.e. is not used during the packaging process). This information can therefore be indicative of whether a component associated with an output of the components is active during the packaging process (i.e. is involved in the packaging process) and/or is inactive during the packaging process (i.e. is not involved in the packaging process). For example, information on the active output of a switch of the packaging plant is indicative for the position of the switch. If it emerges from the switch position of a switch that the component connected to an inactive output of the switch is bypassed during the packaging process, this component is for example not involved in the packaging process and is therefore inactive.

The representation of the packaging process that is feasible by the packaging plant is for example a partial graph and/or a sub-graph of the graph associated with the packaging plant. For example, the representation of the packaging process that is feasible by the packaging plant comprises a subset of the plurality of nodes and/or a subset of the plurality of edges.

For example, the representation of the packaging process that is feasible by the packaging plant is determined such that it only comprises the nodes of the plurality of nodes that represent the active components of the packaging plant during the packaging process.

The graph is therefore a particularly efficient option for the storing and determining of a representation of the packaging process that is feasible by the packaging plant. The complex determining of a representation of all of the packaging processes that are feasible by the packaging plant in advance and the storage of corresponding data are not necessary. Instead, the representation of a packaging process that is feasible by the packaging plant can at least in part be determined based on the graph so only the graph data needs to be stored in a memory of the data processing device for the determining.

According to an exemplary embodiment of the invention, each edge from the plurality of edges is a directed edge. A directed edge represents, for example, a connection between a starting node and an end node, wherein the directed edge is directed from the starting node to the end node.

Furthermore, each edge from the plurality of edges is for example activatable and inactivatable (i.e. deactivatable). The activity of each edge from the plurality of edges is associated at least with the activity of the component of the packaging plant represented by the starting node of the respective edge from the plurality of edges and/or the activity of at least one output (e.g. a predefined output) of the component of the packaging plant represented by the starting node of the respective edge from the plurality of edges.

If the component of the packaging plant represented by the starting nodes of an edge from the plurality of edges only has one output, the activity of this edge is for example associated with the activity of the component of the packaging plant represented by the starting node of the edge and/or with the activity of the output of the component of the packaging plant represented by the starting node of the edge. In this case, the edge is for example only active when the component of the packaging plant represented by the starting node of the edge and/or the output of the component of the packaging plant represented by the starting node of the edge is active.

If the component of the packaging plant represented by the starting node of an edge from the plurality of edges, however, has several outputs, the activity of this edge is for example associated with the activity of at least one output (e.g. a predefined output) of the component of the packaging plant represented by the starting node of the edge. In this case, the edge is accordingly, for example, only active if the at least one output (e.g. the predefined output) of the component of the packaging plant represented by the starting node of the edge is active. This is reasonable, for example, if the edge represents a packaging process connection between this output (e.g. the predefined output) of the component of the packaging plant represented by the starting node of the edge and the component of the packaging plant represented by the end node of the edge.

Furthermore, the activity of one or more edges from the plurality of edges can also be associated with the activity of one or more further nodes (e.g. the end node) and/or the activity of one or more further outputs and/or inputs from one or more further nodes (e.g. the end node). For example, the activity of at least one edge of the plurality of edges can additionally also be associated with the activity of the end node of the edge and/or the activity of at least one input of the end node of the edge. This is for example advantageous if the component of the packaging plant represented by the end node of the edge is inactivatable and/or has one or more inputs that are inactivatable. For example, chutes may have several inputs that cannot all be active at the same time as they are for example mechanically blocked depending on the setting of the chute.

For example, when determining the representation of the packaging process that is feasible by the packaging plant, only active edges from the plurality of edges and nodes from the plurality of nodes connected by active edges from the plurality of edges are taken into account. Furthermore, when determining the representation of the packaging process that is feasible by the packaging plant, for example, no nodes from the plurality of nodes, to which only inactive edges from the plurality of edges are directed and/or which (e.g. exclusively) follow nodes to which only inactive edges are directed, and edges starting from these nodes are taken into account. This is for example advantageous in order to only take into account nodes representing active components of the packaging plant and only edges representing packaging process connections that are used when determining the representation of the packaging process that is feasible by the packaging plant.

For example, the representation of the packaging process that is feasible by the packaging plant is determined such that it comprises only active edges from the plurality of edges and nodes from the plurality of nodes connected by active edges from the plurality of edges. Furthermore, the representation of the packaging process that is feasible by the packaging plant is, for example, determined such that it does not comprise any nodes from the plurality of nodes, to which only inactive edges from the plurality of edges are directed and/or which (e.g. exclusively) follow nodes to which only inactive edges are directed, and edges starting from these nodes.

The determining of the graph can for example be performed by passing the graph from one node to the next node connected with this node through an active edge in the direction of the edge. Therein, it is for example, started with the nodes from the plurality of nodes towards which no edges (e.g. neither an active nor an inactive edge) is directed. The result of the determining is for example a partial and/or sub-graph of the graph that includes all nodes from the plurality of nodes passed through and all edges from the plurality of edges passed through.

According to an exemplary embodiment of the invention, the packaging plant status data are indicative of a packaging process performed by the packaging plant within a certain time frame. This is advantageous for example in order to determine and follow a representation of the packaging process for a package filled by the packaging plant during this period.

According to an exemplary embodiment of the invention, the method further comprises:
providing and/or outputting the representation of the packaging process that is feasible by the packaging plant obtained as a result of the determining.

The providing the representation of the packaging process that is feasible by the packaging plant obtained as a result of the determining can for example be performed by holding available data that represent this representation (e.g. partial graph and/or sub-graph data) for retrieval by another device and/or by communicating these data to one or more other devices. For example, the data processing device comprises a communication interface to this end.

The outputting of the representation of the packaging process that is feasible by the packaging plant obtained as a result of the determining should for example be understood to mean that the representation of the packaging process that is feasible by the packaging plant is output by a user interface (e.g. a graphical user interface) of the data processing device as user information (e.g. as a graphical representation of a partial and/or sub-graph of the graph associated with the packaging plant).

According to an exemplary embodiment of the invention, the packaging plant comprises one or more of the following components:
a heating system,
a filling machine,
an applicator for the application of closures and/or drinking straws
a switch,
a chute,
a shrinker,
a palletiser,
a buffer,
a vertical storage,
a bulk packer and/or
a cartoner.

According to an exemplary embodiment of the invention, the packaging plant comprises at least one filling machine.

The examples and exemplary embodiments of the present invention described above should also be understood to be disclosed in all combinations.

Further advantageous exemplary embodiments of the invention can be inferred from the following detailed description of a number of exemplary embodiments of the invention, in particular in combination with the figures. However, the figures enclosed with the application are only intended to be used for illustration purposes and not to define the scope of protection of the invention. The enclosed drawings are not necessarily true to scale and are simply intended to reflect in exemplary form the general concept of the present invention. In particular, features which are contained in the figures, should in no way be considered as a necessary element of the present invention.

In the drawings:

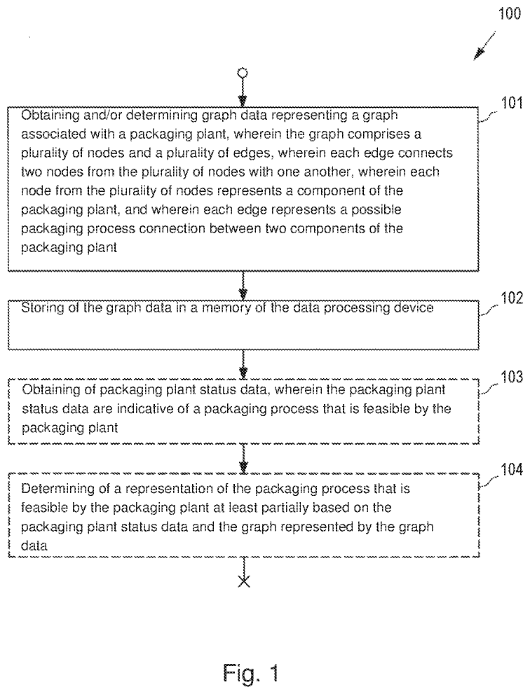

FIG. 1 a flow diagram of an exemplary embodiment of a method according to the invention;

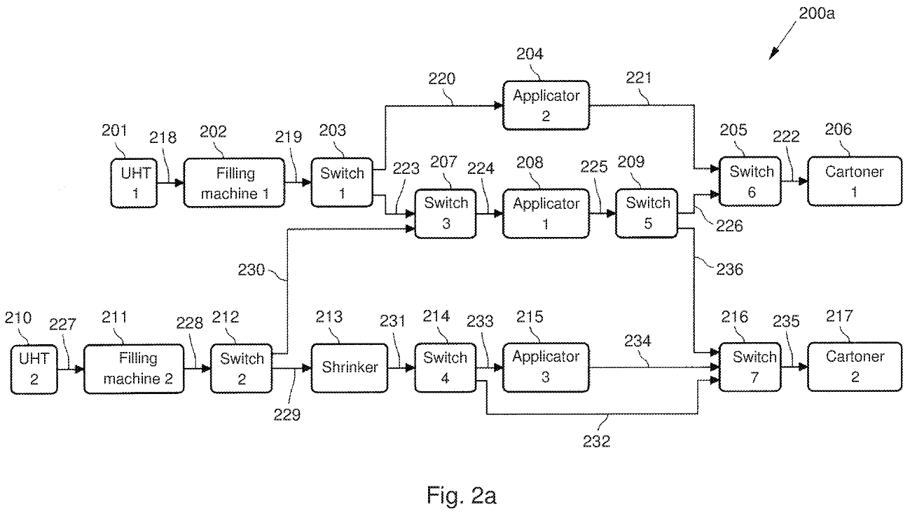

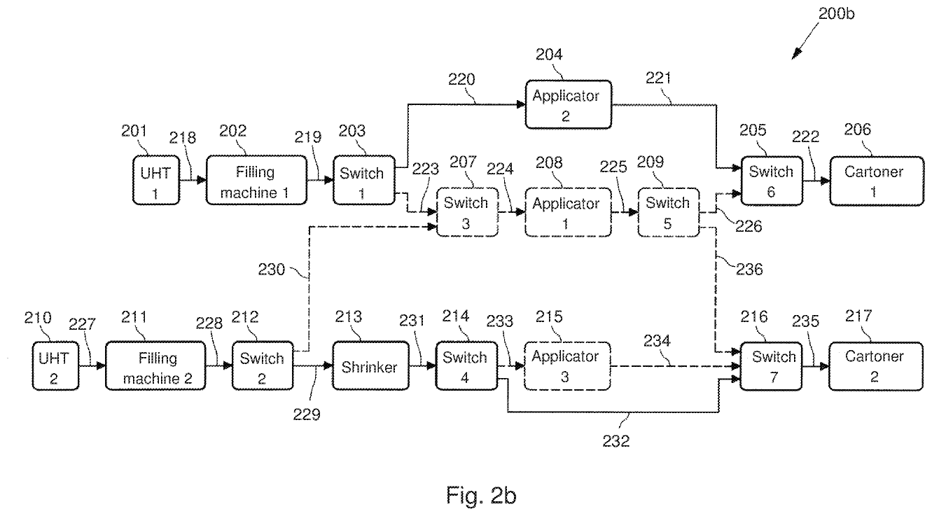

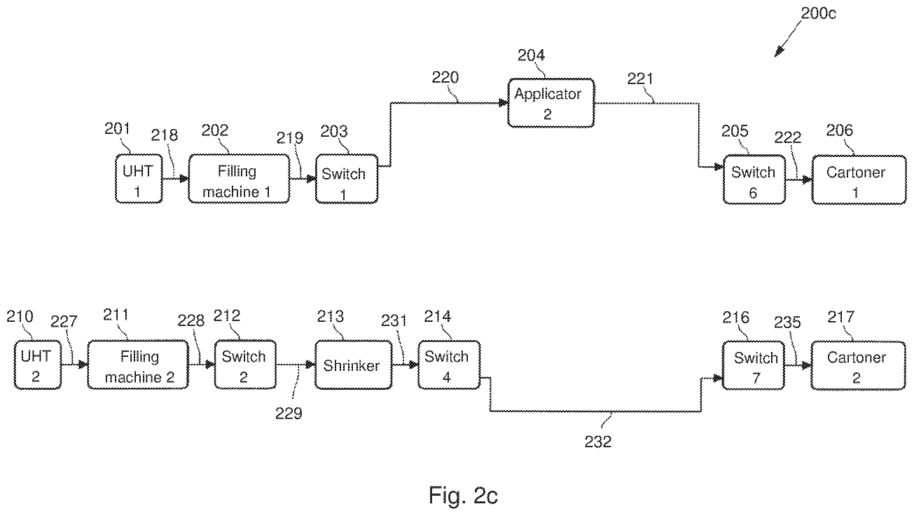

FIG. 2a an exemplary graph associated with a packaging plant;

FIG. 2b-2c exemplary sub-graphs and/or partial graphs as respective representations of a packaging process that is feasible by a packaging plant;

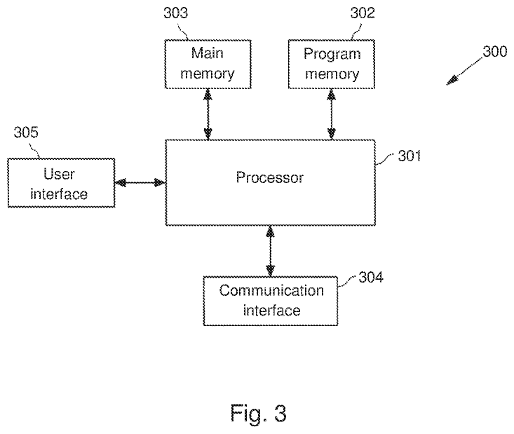

FIG. 3 a schematic representation of an exemplary embodiment of a data processing device according to the invention; and

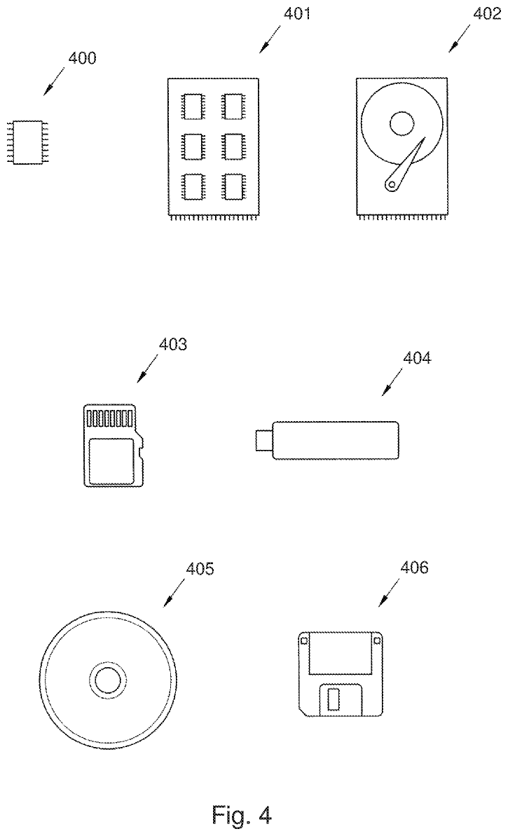

FIG. 4 exemplary embodiments of storage media.

### DETAILED DESCRIPTION OF A NUMBER OF EXEMPLARY EMBODIMENTS OF THE INVENTION

FIG. 1 shows a flow diagram 100 with steps of an exemplary embodiment of a method according to the invention. Steps 101 to 104 of the flow diagram 100 can for example be performed by a data processing device according to the invention such as the data processing device 300 shown in FIG. 3.

In a first step 101, graph data representing a graph associated with a packaging plant are obtained and/or determined.

The obtaining of graph data should for example be understood to mean that the graph data are received by the data processing device via a communication connection and/or read from a portable storage device and/or recorded in the form of user input. The data processing device 300 according to the invention shown in FIG. 3 has for example a communication interface 304 for receiving the graph data via a communication connection and a user interface 305 for recording of the graph data in the form of user input.

Alternatively or in addition, the graph data can be determined by the data processing device. The determining of the graph data should be understood to mean generating and/or calculating the graph data. The determining of the graph data can for example be performed at least partially based on data obtained by the data processing device (e.g. data received by the data processing device via a communication connection and/or read from a portable storage device and/or recorded in the form of a user input) and/or at least partially based on predefined rules (e.g. rules of an algorithm) for determining of a graph associated with a packaging plant and/or for determining of graph data that represent a graph associated with a packaging plant.

FIG. 2a shows an exemplary graph 200a associated with a packaging plant. Graph 200a is associated with a beverage filling plant as a packaging plant. A plurality of different components are often used in plants of this type such as heating systems (e.g. heating systems for the ultra-high-temperature heating of the filling material), filling machines, applicators for the application of closures and/or drinking straws, switches (e.g. switches for the separation and/or combination of packaging process connections), shrinkers, chutes, bulk packers, palletisers, buffers, vertical storages and cartoners.

Graph 200a comprises a plurality of nodes 201 to 217 and a plurality of edges 218 to 235.

Each node from the plurality of nodes 201 to 217 represents a component of the packaging plant. In FIG. 2a the name of the component of the packaging plant represented by the node in question is superimposed on the respective node as an inscription. For example, node 201 represents the heating system UHT 1, node 202 represents filling machine 1, node 203 represents switch 1, node 204 represents applicator 2, node 205 represents switch 6, node 206 represents cartoner 1 etc.

Furthermore, each edge from the plurality of edges 218 to 235 represents a possible packaging process connection between two components of the packaging plant. A packaging process connection is for example a connection between two of components of the packaging plant that can be used during a packaging process that is feasible by the packaging plant. A packaging process connection of this type can for example be formed by a conveyor line (e.g. as a conveyor belt and/or as a roller conveyor) between the output of a component and the input of another component in the packaging plant.

In graph 200a, the edges are directed edges, each of which is directed from a starting node to an end node. The direction of an edge from the plurality of edges 218 to 235 corresponds to the direction of the packaging process connection represented by the respective edge. For example, edge 218, which is directed in line with the direction of the arrow from starting node 201 to end node 202, represents a packaging process connection from an output of the heating system UHT 1 to an input of the filling machine 1.

In order for one packaging plant to be able to perform various packaging processes, components with several outputs and/or inputs (e.g. switches) can be provided in the packaging plant which enable the bypassing of components in the packaging plant. If a component (e.g. a switch for splitting of a packaging process connection) of the packaging plant has different outputs that are connected to inputs of different components of the packaging plant, each of these process connections can for example be represented by a respective edge from the plurality of edges. This also applies accordingly when a component (e.g. a switch to combine several packaging process connections) has several inputs that are connected to the outputs of different components of the packaging plant.

For example, switch 1 represented by node 203 has an input and two outputs in order to split the packaging process connection from an output of filling machine 1 into a first packaging process connection to an input of applicator 2 and a second packaging process connection to an input of switch 3. Accordingly, graph 200a has an edge 219 that represents a packaging process connection from an output of filling machine 1 to the input of switch 1. Furthermore, graph 200a has an edge 220 that represents a packaging process connection from the first output of switch 1 to an input of applicator 2 and an edge 223 that represents a packaging process connection from the second output of switch 1 to an input of switch 3. Switch 3, which is represented by node 207, however, has two inputs and one output in order to combine the packaging process connection of an output of switch 1 and the packaging process connection of an output of switch 2. This is represented in graph 200a by edges 223, 230 and 224.

Furthermore, each edge from the plurality of edges 218 to 235 is for example activatable and inactivatable (i.e. deactivatable). The activity of each edge from the plurality of edges 218 to 235 is at least associated with the activity of the component represented by the starting node of the respective edge from the plurality of edges and/or the activity of at least one output (e.g. a predefined output) of the component of the packaging plant represented by the starting nodes of the respective edge from the plurality of edges. For example, the activity of the above-mentioned edge 220 is associated with the first output of switch 1 such that the edge 220 is only active when the first output of switch 1 is active. Accordingly, the activity of edge 223 as described above can for example be associated with the second output of switch 1 such that edge 223 is only active if the second output of switch 1 is active. Edges from the plurality of edges 218 to 235 such as edge 218 as described above, the starting nodes of which each represent a component with just a single output are for example active as default. This is advantageous, for example, if the respective components and their outputs are permanently active. For each other edge from the plurality of edges 218 to 235, it is possible to determine in an optional step 104 whether the respective edge is active and/or inactive when a representation of the packaging process that is feasible by the packaging plant is determined. Alternatively, the determining can be performed for each edge from the plurality of edges 218 to 235 in the optional step 104.

Below, the assumption is made that the graph data obtained and/or determined in step 101 represents the graph 200a. For example, to this end the graph data contain corresponding data structures (e.g. the node and edge data structures disclosed above) that define the plurality of nodes 201 to 217 and the plurality of edges 218 to 235 of graph 200a.

In a step 102 the graph data are stored in a memory of the data processing device. For example, the graph data are stored in the program memory 302 and/or the main memory 303 of the data processing device according to the invention shown in FIG. 3.

In an optional step 103, packaging plant status data are obtained, wherein the packaging plant status data are indicative of a packaging process that is feasible by the packaging plant associated with the graph 200a.

As disclosed above, various packaging processes may differ by the components of the packaging plant involved in the implementation of the packaging process. Below, the assumption is therefore made that the packaging plant status data are at least indicative of the active output of the components with several outputs that are part of the packaging plant associated with the graph 200a. For example, the packaging plant status data contain information on the active output of these components with several outputs, for example this information is indicative of which output of the respective component is active during the packaging process (i.e. is used during the packaging process) and which output of the respective component is inactive during the packaging process (i.e. is not used during the packaging process). For example, the following components of the packaging plant associated with graph 200a have several outputs: Switch 1, switch 2, switch 4 and switch 5.

The packaging plant status data are for example communicated from one or more components (e.g. switches 1, 2, 4 and 5) of the packaging plant to the data processing device via one or more communication connections. The packaging plant status data is obtained for example by receiving the packaging plant status data by the data processing device. Alternatively or additionally, the packaging plant status data can be recorded at least in part in the form of user input to the data processing device. For example, the data processing device 300 in FIG. 3 comprises appropriate means such as a communication interface 304 for receiving of data and/or a user interface 305 for recording of data in the form of user input.

In an optional step 104 a representation of the packaging process that is feasible by the packaging plant is determined at least partially based on the packaging plant status data obtained in step 103 and on the graph 200a. A representation of the packaging process that is feasible by the packaging plant can for example be understood to be a partial graph or sub-graph of graph 200a. Exemplary partial graphs and/or sub-graphs 200b and 200c of graph 200a are shown in FIGS. 2b and 2c.

As disclosed above, the edges from the plurality of edges 218 to 235 are at least partially activatable and inactivatable. For example the determining of the representation of the packaging process that is feasible by the packaging plant in step 104 as disclosed above can comprise the determining of the active and/or inactive edges from the plurality of edges 218 to 235 at least partially based on the packaging plant status data obtained in step 103 and the graph 200a. If for example packaging plant status data are obtained in step 103 that are indicative of the output of switch 1 that is connected to switch 3, the output of switch 2 that is connected to switch 3, the output of switch 4 that is connected to applicator 3 and the output of switch 5 that is connected to switch 6 being inactive, it is for example determined that edges 223, 230, 233 and 226 of graph 200a are inactive. Furthermore, it is also determined that the other edges from the plurality of edges 218 to 235 are active.

For example, the representation of the packaging process that is feasible by the packaging plant in step 104 is determined such that it only comprises active edges from the plurality of edges and nodes from the plurality of nodes connected by active edges. Furthermore, the representation of the packaging process to be performed by the packaging plant in step 104 is, for example, determined such that it does not comprise nodes from the plurality of nodes 201 to 217, to which only inactive edges from the plurality of edges 218 to 235 are directed and/or which (e.g. exclusively) follow nodes to which only inactive edges are directed, and edges starting from these nodes.

The determining of the representation can for example be performed by passing the graph 200a from one node to the next node connected to this node by an active edge in the direction of the edge. For example, the process starts with the nodes 201 and 210 from the plurality of nodes towards which no edges (e.g. neither an active nor an inactive edge) is directed. The result of the determining is for example a partial graph and/or sub-graph of the graph 200a that includes all nodes from the plurality of nodes 201 to 217 passed through and all edges from the plurality of edges 218 to 235 passed through. In the example described above in which it is determined that edges 223, 230, 233 and 226 of graph 200a are inactive, components 207, 208, 209 and 215 shown with dotted lines in FIG. 2b and edges 223, 224, 225, 226, 230, 233 and 234 shown with dotted lines are accordingly not taken into account when determining the representation in step 104 as these components and edges are not passed through. As a result of the determining in step 104, in this example the partial graph and/or sub-graph 200c of graph 200a shown in FIG. 2c is therefore obtained.

The representation determined in step 104 can then be output (e.g. via a graphical user interface of the data processing device).

FIG. 3 is a schematic representation of an exemplary embodiment of a data processing device 300 according to the invention.

The data processing device 300 comprises a processor 301 and connected to the processor 301 a first memory as a program and data memory 302, a second memory as a main memory 303, a communication interface 304 and a user interface 305.

A processor should be understood to be a microprocessor, a microcontrol unit, a microcontroller, a Digital Signal Processor (DSP), an Application-Specific Integrated Circuit (ASIC) or a Field Programmable Gate Array (FPGA). It is understood that the data processing device 300 can also comprise several processors 10.

Processor 301 executes program instructions that are stored in the program memory 302 and stores for example interim results or the like in the main memory 303.

A program memory should be understood for example to be the memory of the data processing device in which computer programs, program instructions and data are permanently stored. A main memory is for example the memory of the data processing device that contains the computer programs and/or program instructions executed by a processor of the data processing device and in which for example interim results or the like can be stored (e.g. cached).

For example, the program memory 302 and/or the main memory 303 can contain the graph data as disclosed above (e.g. the graph data are stored in step 102 of the flow diagram 100 shown in FIG. 1 in program memory 302 and/or the main memory 303). The program memory 302 further contains program instructions of a computer program according to the invention that comprises program instructions which allow the processor 301 to perform and/or to control the method according to the invention (e.g. the method according to flow diagram 100 shown in FIG. 1) when the processor 301 executes the program instructions stored in program memory 302. Program memory 302 can also contain, for example, the operating system of the data processing device 300, which is loaded on start-up of the data processing device 300 at least in part in the main memory 303 and performed by processor 301. In particular, on start-up of the data processing device 300 at least part of the core of the operating system in the main memory 303 is loaded and performed by processor 301.

An example of an operating system is a Windows, UNIX, Linux, Android, Apple iOS and/or Mac OS operating system. The operating system enables the use of data processing device 300 for data processing. For example, it manages operating elements such as a main memory and a program memory, provides fundamental functions to other computer programs among other things by programming interfaces and controls the execution of computer programs.

A program memory is for example a non-volatile memory such as a flash drive, a magnetic memory, an EEPROM memory (electrically erasable programmable read-only memory) and/or an optical memory. A main memory is for example a volatile or non-volatile memory, in particular a memory with random-access memory (RAM) such as a static RAM memory (SRAM), a dynamic RAM memory (DRAM), a ferroelectric RAM memory (FeRAM) and/or a magnetic RAM memory (MRAM).

The main memory 303 and the program memory 302 can also be formed as one memory. Alternatively, the main memory 303 and/or the program memory 302 can each be formed by several memories. Furthermore, the main memory 303 and/or the program memory 302 can also be part of the processor 301.

Processor 301 also controls the communication interface 304.

A communication interface can for example receive data according to a communication technique and forward this data to the processor and/or receive data from the processor and send it according to a communication technique. Examples of a communication technique of this type include communication connections via a communication network such as an Ethernet network and/or a WLAN network. Ethernet networks are for example specified in the standards of the IEEE-802.3 family; and WLAN is for example specified in the standards of the IEEE-802.11 family. Further examples of a communication technique of this type are communication connections via a bus system such as real-time Ethernet networks (e.g. EtherCAT, which is specified among other places in standards IEC-61158 and IEC-61784-2).

Processor 301 also controls the graphical user interface 305 which is configured to output graphical information to a user. Furthermore, the graphical user interface can for example also be configured to record user inputs from a user (e.g. by recording contact with the graphical user interface). A graphical user interface should for example be understood to be a screen (e.g. a touch-sensitive screen).

Components 301 to 305 of the data processing device 300 are for example connected to one another on a communicative and/or operative level via one or more bus systems (e.g. one or more serial and/or parallel bus connections).

It is understood that the data processing device 300 can comprise further components (e.g. one or more further communication interfaces and/or one or more further user interfaces) in addition to components 301 to 305.

Finally, FIG. 4 shows exemplary embodiments of storage media on which an embodiment of a computer program according to the invention can be stored. The storage medium can for example be a magnetic, electric, optic and/or other type of storage medium. The storage medium can for example be part of a processor (e.g. processor 301 in FIG. 3), for example a (non-volatile or volatile) program memory of the processor or a part of this (e.g. memory 302 in FIG. 3). Exemplary embodiments of a storage medium are a flash drive 400, an SSD hard drive 401, a magnetic hard drive 402, a memory card 403, a memory stick 404 (e.g. a USB stick), a CD-ROM or DVD 405 or a floppy disk 406.

The examples and exemplary embodiments of this invention described in this specification should also be understood to be disclosed in all combinations. In particular, unless otherwise declared the description of a feature comprised by an embodiment is not to be understood as the feature being essential or substantial to the function of the embodiment. The sequence of the method steps shown in this specification in the individual flow diagrams is not authoritative and alternative sequences of the method steps are conceivable. The method steps can be implemented in various manners, so implementation in software (through program instructions), hardware or a combination of the two is conceivable for the implementation of the method steps. Terms such as “comprise”, “have”, “Include”, “contain” and the like used in the claims do not exclude other elements or steps. Both “partial” and “complete” are included under the formulation “at least partially”. The formulation “and/or” should be understood to mean that both the alternative and the combination is to be disclosed, so “A and/or B” means “(A) or (B) or (A and B)”. A plurality of units, persons or the like means several units, persons or the like in the context of this specification. The use of an indefinite article does not exclude a plurality. A single device can perform the functions of several units or devices mentioned in the claims. The reference numbers given in the claims are not to be seen as limitations of the means and steps used.

1. A method performed by a data processing device, the method comprising:
obtaining and/or determining graph data, wherein the graph data represent a graph associated with a packaging plant, wherein the graph comprises a plurality of nodes and a plurality of edges, wherein each edge from the plurality of edges connects two nodes from the plurality of nodes with one another, wherein each node from the plurality of nodes represents a component of the packaging plant, and wherein each edge from the plurality of edges represents a possible packaging process connection between two components of the packaging plant; and
storing of the graph data in a memory of the data processing device;
receiving of packaging plant status data, wherein the packaging plant status data are indicative of a packaging process that is feasible by the packaging plant; and
wherein the packaging plant status data is communicated to the data processing device by one or more components of the packaging plant via a communication connection; and
determining of a representative of the packaging process that is feasible by the packaging plant at least partially based on the packaging plant status data and the graph represented by the graph data,
wherein the representation of the feasible packaging process of the packaging plant comprises at least one of a subset of a plurality of nodes and/or a subset of a plurality of edges.

2. The method according to claim 1, wherein the packaging plant is configured to perform at least two different packaging processes.

3. The method according to claim 1,
wherein the graph associated with a packaging plant represents all packaging processes feasible by the packaging plant.

4. The method according to claim 3, wherein the packaging plant status data contain information on at least one of the activity or the active output of one or more components of the packaging plant.

5. The method according to claim 4, wherein each edge from the plurality of edges is a directed edge, wherein each edge from the plurality of edges is activatable and inactivatable and wherein the activity status of each edge from the plurality of edges is at least associated with the activity or with the active output of the components of the packaging plant represented by the starting node of the respective edge from the plurality of edges.

6. The method according to claim 5, wherein when determining the representation of the packaging process that is feasible by the packaging plant, only active edges from the plurality of edges and nodes from the plurality of nodes connected by active edges from the plurality of edges are taken into account.

7. The method according to claim 3, wherein the packaging plant status data are indicative of a packaging process performed by the packaging plant within a certain time frame.

8. The method according to claim 3, the method further comprising:
providing or outputting of the representation of the packaging process that is feasible by the packaging plant obtained as result of the determining.

9. The method according to claim 1, wherein the packaging plant comprises one or more of the following components:
a heating system,
a filling machine,
an applicator for the application of at least one of closures or drinking straws,
a switch,
a chute,
a bulk packer,
a palletiser,
a buffer,
a vertical storage,
a cartoner.

10. A non-transitory computer readable storage medium in which a computer program is stored, the computer program comprising program instructions that cause a processor to perform or control:
obtaining or determining graph data, wherein the graph data represent a graph associated with a packaging plant, wherein the graph comprises a plurality of nodes and a plurality of edges, wherein each edge from the plurality of edges connects two nodes from the plurality of nodes with one another, wherein each node from the plurality of nodes represents a component of the packaging plant, and wherein each edge from the plurality of edges represents a possible packaging process connection between two components of the packaging plant;
storing of the graph data in a memory of the data processing device;
receiving of packaging plant status data, wherein the packaging plant status data are indicative of a packaging process that is feasible by the packaging plant; and
wherein the packaging plant status data is communicated to the data processing device by one or more components of the packaging plant via a communication connection; and
determining of a representation of the packaging process that is feasible by the packaging plant at least partially based on the packaging plant status data and the graph represented by the graph data,
wherein the representation of the feasible packaging process of the packaging plant comprises at least one of a subset of a plurality of nodes or a subset of a plurality of edges.

11. A data processing device comprising at least one processor and at least one memory including computer program code, wherein the at least one memory and the computer program code are configured to, with the at least one processor, cause the data processing device or perform or control:
obtaining or determining graph data, wherein the graph data represent a graph associated with a packaging plant, wherein the graph comprises a plurality of nodes and a plurality of edges, wherein each edge from the plurality of edges connects two nodes from the plurality of nodes with one another, wherein each node from the plurality of nodes represents a component of the packaging plant, and wherein each edge from the plurality of edges represents a possible packaging process connection between two components of the packaging plant;
storing of the graph data in a memory of the data processing device;
receiving of packaging plant status data, wherein the packaging plant status data are indicative of a packaging process that is feasible by the packaging plant; and
wherein the packaging plant status data is communicated to the data processing device by one or more components of the packaging plant via a communication connection; and
determining of a representation of the packaging process that is feasible by the packaging plant at least partially based on the packaging plant status data and the graph represented by the graph data,
wherein the representation of the feasible packaging process of the packaging plant comprises at least one of a subset of a plurality of nodes or a subset of a plurality of edges.

12. A system, comprising:
a data processing device according to claim 11; and
a packaging plant.

13. The data processing device according to claim 11, wherein the packaging plant is configured to perform at least two different packaging processes.

14. The data processing device according to claim 11, wherein the graph associated with a packaging plant represents all packaging processes feasible by the packaging plant.

15. The data processing device according to claim 14, wherein the packaging plant status data contain information on at least one of the activity or the active output of one or more components of the packaging plant.

16. The data processing device according to claim 15, wherein each edge from the plurality of edges is a directed edge, wherein each edge from the plurality of edges is activatable and inactivatable and wherein the activity status of each edge from the plurality of edges is at least associated with the activity or with the active output of the components of the packaging plant represented by the starting node of the respective edge from the plurality of edges.

17. The data processing device according to claim 16, wherein when determining the representation of the packaging process that is feasible by the packaging plant, only active edges from the plurality of edges and nodes from the plurality of nodes connected by active edges from the plurality of edges are taken into account.

18. The data processing device according to claim 14, wherein the packaging plant status data are indicative of a packaging process performed by the packaging plant within a certain time frame.

19. The data processing device according to claim 14, wherein the at least one memory and the computer program code are further configured to, with the at least one processor, cause the data processing device to perform or control:
providing or outputting of the representation of the packaging process that is feasible by the packaging plant obtained as result of the determining.

20. The data processing device according to claim 11, wherein the packaging plant comprises one or more of the following components:
a heating system,
a filling machine,
an applicator for the application of at least one of closures or drinking straws,
a switch,
a chute,
a bulk packer,
a palletiser,
a buffer,
a vertical storage, or
a cartoner.
